(19) United States
(12) Patent Application Publication
(10) Pub. No.: US 2008/0061027 A1
(43) Pub. Date: Mar. 13, 2008

(54) Method for forming a micro fuel cell

(76) Inventors: Pawitter S. Mangat, Gilbert, AZ (US); John J. D'Urso, Chandler, AZ (US); Chowdary R. Koripella, Scottsdale, AZ (US); Ramkumar Krishnan, Gilbert, AZ (US)

Correspondence Address: INGRASSIA FISHER & LORENZ, P.C., 7150 E. CAMELBACK, STE. 325, SCOTTSDALE, AZ, 85251, US

(21) Appl. No.: 11/519,553

(22) Filed: Sep. 12, 2006

(51) Int. Cl. H01B 13/00; B05D 5/12; H01M 8/02

(52) U.S. Cl. 216/17; 427/115; 429/38

(57) ABSTRACT

A method is provided for fabricating a fuel cell that requires only front side alignment techniques to fabricate gas access holes. The method comprises etching the front side of a substrate (12) to provide a channel (24, 26), and forming a pedestal (54, 88) on the front side of the substrate, wherein the pedestal (54, 88) comprises an anode side (56, 89) defining a fuel region (68, 102) aligned with the channel (24, 26). An electrolyte (46, 96) is positioned between the anode side (56, 89) and a cathode side (58, 90), and the fuel region (68, 102) is capped with an insulator (66, 98). A portion of the substrate (12) is removed from a back side to expose the channel (24, 26).

### RELATED APPLICATIONS

This application relates to U.S. application Ser. No. 11/363,790, Integrated Micro Fuel Cell Apparatus, filed 28 Feb. 2006, and U.S. application Ser. No. 11/479,737, Fuel Cell Having Patterned Solid Proton Conducting Electrolytes, filed 30 Jun. 2006.

### FIELD OF THE INVENTION

The present invention generally relates to fuel cells and more particularly to a method of fabricating a micro fuel cell and for providing gas access to the micro fuel cell that requires only front side alignment and processing.

### BACKGROUND OF THE INVENTION

Rechargeable batteries are currently the primary power source for cell phones and various other portable electronic devices. The energy stored in the batteries is limited. It is determined by the energy density (Wh/L) of the storage material, its chemistry, and the volume of the battery. For example, for a typical Li ion cell phone battery with a 250 Wh/L energy density, a 10 cc battery would store 2.5 Wh of energy. Depending upon the usage, the energy could last for a few hours to a few days. Recharging always requires access to an electrical outlet. The limited amount of stored energy and the frequent recharging are major inconveniences associated with batteries. Accordingly, there is a need for a longer lasting, easily recharging solution for cell phone power sources. One approach to fulfill this need is to have a hybrid power source with a rechargeable battery and a method to trickle charge the battery. Important considerations for an energy conversion device to recharge the battery include power density, energy density, size, and the efficiency of energy conversion.

Energy harvesting methods such as solar cells, thermoelectric generators using ambient temperature fluctuations, and piezoelectric generators using natural vibrations are very attractive power sources to trickle charge a battery. However, the energy generated by these methods is small, usually only a few milliwatts. In the regime of interest, namely, a few hundred milliwatts, this dictates that a large volume is required to generate sufficient power, making it unattractive for cell phone type applications.

An alternative approach is to carry a high energy density fuel and convert this fuel energy with high efficiency into electrical energy to recharge the battery. Radioactive isotope fuels with high energy density are being investigated for portable power sources. However, with this approach the power densities are low and there also are safety concerns associated with the radioactive materials. This is an attractive power source for remote sensor-type applications, but not for cell phone power sources. Among the various other energy conversion technologies, the most attractive one is fuel cell technology because of its high efficiency of energy conversion and the demonstrated feasibility to miniaturize with high efficiency.

Fuel cells with active control systems and those capable of operating at high temperatures are complex systems and are very difficult to miniaturize to the 2-5 cc volume needed for cell phone application. Examples of these include active control direct methanol or formic acid fuel cells (DMFC or DFAFC), reformed hydrogen fuel cells (RHFC), and solid oxide fuel cells (SOFC). Passive air-breathing hydrogen fuel cells, passive DMFC or DFAFC, and biofuel cells are attractive systems for this application. However, in addition to the miniaturization issues, other concerns include supply of hydrogen for hydrogen fuel cells, lifetime and energy density for passive DMFC and DFAFC, and lifetime, energy density and power density with biofuel cells.

Conventional DMFC and DFAFC designs comprise planar, stacked layers for each cell. Individual cells may then be stacked for higher power, redundancy, and reliability. The layers typically comprise graphite, carbon or carbon composites, polymeric materials, metal such as titanium and stainless steel, and ceramic. The functional area of the stacked layers is restricted, usually on the perimeter, by vias for bolting the structure together and accommodating the passage of fuel and an oxidant along and between cells. Additionally, the planar, stacked cells derive power only from a fuel/oxidant interchange in a cross-sectional area (x and y coordinates).

To design a fuel cell/battery hybrid power source in the same volume as a typical mobile device battery (10 cc-2.5 Wh), both a smaller battery and a fuel cell with high power density and efficiency would be required to achieve an overall energy density higher than that of the battery alone. For example, for a 4-5 cc (1.0-1.25 Wh) battery to meet the peak demands of the phone, the fuel cell would need to fit in 1-2 cc, with the fuel taking up the rest of the volume. The power output of the fuel cell needs to be 0.5 W or higher to be able to recharge the battery in a reasonable time. Most development activities on small fuel cells are attempts to miniaturize traditional fuel cell designs, and the resultant systems are still too big for mobile applications. A few micro fuel cell development activities have been disclosed using traditional silicon processing methods in planar fuel cell configurations, and in a few cases, porous silicon is employed to increase the surface area and power densities. See, for example, U.S. Patent/Publication Nos. 2004/0185323, 2004/0058226, U.S. Pat. No. 6,541,149, and 2003/0003347. However, the power densities of the air-breathing planar hydrogen fuel cells are typically in the range of 50-100 mW/cm². To produce 500 mW would require 5 cm² or more active area. Further, the operating voltage of a single fuel cell is in the range of 0.5-0.7V. At least four to five cells need to be connected in series to bring the fuel cell operating voltage to 2-3V and for efficient DC-DC conversion to 4V in order to charge the Li ion battery. Therefore, the traditional planar fuel cell approach will not be able to meet the requirements in a 1-2 cc volume for a fuel cell in the fuel cell/battery hybrid power source for cell phone use.

In a microfabricated fuel cell, typically, supply of hydrogen is provided by etching holes through the backside of the substrate. With a stacked structure as described in 2004/0185323, 2004/0058226, U.S. Pat. No. 6,541,149, and 2003/0003347, alignment of the holes is not critical as all the holes reach to the anode. However, for any 3-D fuel cell with anodes and cathodes arranged in the same plane of the substrate, alignment of holes providing hydrogen access is critical.

Accordingly, it is desirable to provide an integrated micro fuel cell apparatus that derives power from a three-dimensional fuel/oxidant interchange having increased surface area and that requires only front side alignment and processing. In any typical polymer electrolyte fuel cell, the kinetics of the hydrogen oxidation reaction are faster on the anode side compared to the oxygen reduction reaction on the cathode side. It is desirable to increase both of these reaction rates, but particularly the oxygen reaction rate by increasing the catalytic activity or by providing higher surface area for the reaction. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A method is provided for fabricating a fuel cell that requires only front side alignment techniques to fabricate gas access holes. The method comprises etching the front side of a substrate to provide a plurality of channels, and forming a plurality of pedestals on the front side of the substrate, wherein each of the pedestals comprise an anode side defining a fuel region aligned with one of the channels. An electrolyte is positioned between each of the anode sides and a cathode sides, and each fuel region is capped with an insulator. A portion of the substrate is removed from a back side to expose the channels.

### BRIEF DESCRIPTION OF THE DRAWINGS

The present invention will hereinafter be described in conjunction with the following drawing figures, wherein like numerals denote like elements, and

FIGS. 1-6 and 9-13 are partial cross-sectional views of two fuel cells as fabricated in accordance with an exemplary embodiment;

FIGS. 1-4, 7-13 are partial cross-sectional views of a fuel cell as fabricated in accordance with a second exemplary embodiment;

FIG. 14 is a partial cross-sectional top view taken along the line 12-12 of FIG. 13;

FIGS. 15-21 are partial cross-sectional views of two fuel cells as fabricated in accordance with another exemplary embodiment; and

FIG. 22 is a partial cross-sectional top view taken along the line 22-22 of FIG. 21.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The main components of a micro fuel cell device are a proton conducting electrolyte separating the reactant gases of the anode and cathode regions, an electrocatalyst which helps in the oxidation and reduction of the gas species at the anode and cathode of the fuel cell, a gas diffusion region to provide uniform reactant gas access to the anode and cathode, and a current collector for efficient collection and transportation of electrons to a load connected across the fuel cell. Other optional components are an ionomer intermixed with electrocatalyst and/or a conducting support for electrocatalyst particles that help in improving performance. In fabrication of the micro fuel cell structures, the design, structure, and processing of the electrolyte and electrocatalyst are critical to high energy and power densities, and improved lifetime and reliability. A process is described herein to improve the surface area of the micro fuel cell, resulting in enhanced electrochemical contact area, a miniaturized high aspect ratio three-dimensional fuel cell, and a simplified integration and processing scheme that requires only front side alignment and processing. The three-dimensional fuel cell is integrated as a plurality of micro fuel cells. One known way of fabricating micro fuel cells incorporates forming the fuel cells structure on the top surface and etching the silicon from the back side precisely under the anodes to provide fuel access. Front to back alignment of the features, as well as etching very high aspect ratio holes through the thickness of the wafer, provides gas access to anode areas by etching the front side of the substrate to provide vias. The vias may be optionally filled with a material formed by conventional semiconductor processes that can later be easily removed and the substrate can be planarized using techniques such as chemical mechanical planarization to yield a planar substrate for further fuel cell fabrication processing. After complete fabrication of fuel cell, the backside of the substrate can be lapped or chemically etched to expose the via. The material filled in the via can then be removed to obtain a pathway for hydrogen access to the anodes in the plurality of micro fuel cells. Many advantages are realized by the above mentioned processes to fabrication of micro fuel cells. The process requires only front side alignment and processing, eliminates constraints on wafer size and thickness, and provides for sub-twenty micron vias for gas access to each cell, allows for the fabrication of miniaturized high aspect ratio fuel cells with increased surface area, and increased density leading to an increase in the number of cells, and hence, power density.

Fabrication of individual micro fuel cells comprises high aspect ratio three dimensional anodes and cathodes with sub-100 micron dimension provides a high surface area for electrochemical reaction between a fuel (anode) and an oxidant (cathode). At these small dimensions, precise alignment of the anode, cathode, electrolyte and current collectors is required to prevent shorting of the cells. This alignment may be accomplished by semiconductor processing methods used in integrated circuit processing. Functional cells may also be fabricated in ceramic, glass or polymer substrates. This method of fabricating a three-dimensional micro fuel cell has a surface area greater than the substrate and, therefore, higher power density per unit volume.

The fabrication of integrated circuits, microelectronic devices, micro electro mechanical devices, microfluidic devices, and photonic devices, involves the creation of several layers of materials that interact in some fashion. One or more of these layers may be patterned so various regions of the layer have different electrical or other characteristics, which may be interconnected within the layer or to other layers to create electrical components and circuits. These regions may be created by selectively introducing or removing various materials. The patterns that define such regions are often created by lithographic processes. For example, a layer of photoresist material is applied onto a layer overlying a wafer substrate. A photomask (containing clear and opaque areas) is used to selectively expose this photoresist material by a form of radiation, such as ultraviolet light, electrons, or x-rays. Either the photoresist material exposed to the radiation, or that not exposed to the radiation, is removed by the application of a developer. An etch may then be applied to the layer not protected by the remaining resist, and when the resist is removed, the layer overlying the substrate is patterned. Alternatively, an additive process could also be used, e.g., building a structure using the photoresist as a template.

Parallel micro fuel cells in three dimensions fabricated using optical lithography processes typically used in semiconductor integrated circuit processing just described produces fuel cells with the required power density in a small volume. The cells may be connected in parallel or in series to provide the required output voltage. Functional micro fuel cells are fabricated in micro arrays (formed as pedestals) in the substrate. The anode/cathode ion exchange occurs in three dimensions with the anode and cathode areas separated by an insulator. Gasses comprising an oxidant, e.g., ambient air, and a fuel, e.g., hydrogen, are supplied on opposed sides of the substrate. A vertical channel (via) is created by front side processing before fabricating the fuel cell structure on the top allow the precise alignment of the hydrogen fuel access hole under the anode, with this method, without the need for higher dimensional tolerances required for the front to back alignment process, allows for the fabrication of much smaller size high aspect ratio cells.

In the three-dimensional micro fuel cell design of the exemplary embodiment with thousands of micro fuel cells connected in parallel, the current carried by each cell is small. In case of failure in one cell, in order to maintain a constant current, it will cause only a small incremental increase in current carried by the other cells in the parallel stack without detrimentally affecting their performance.

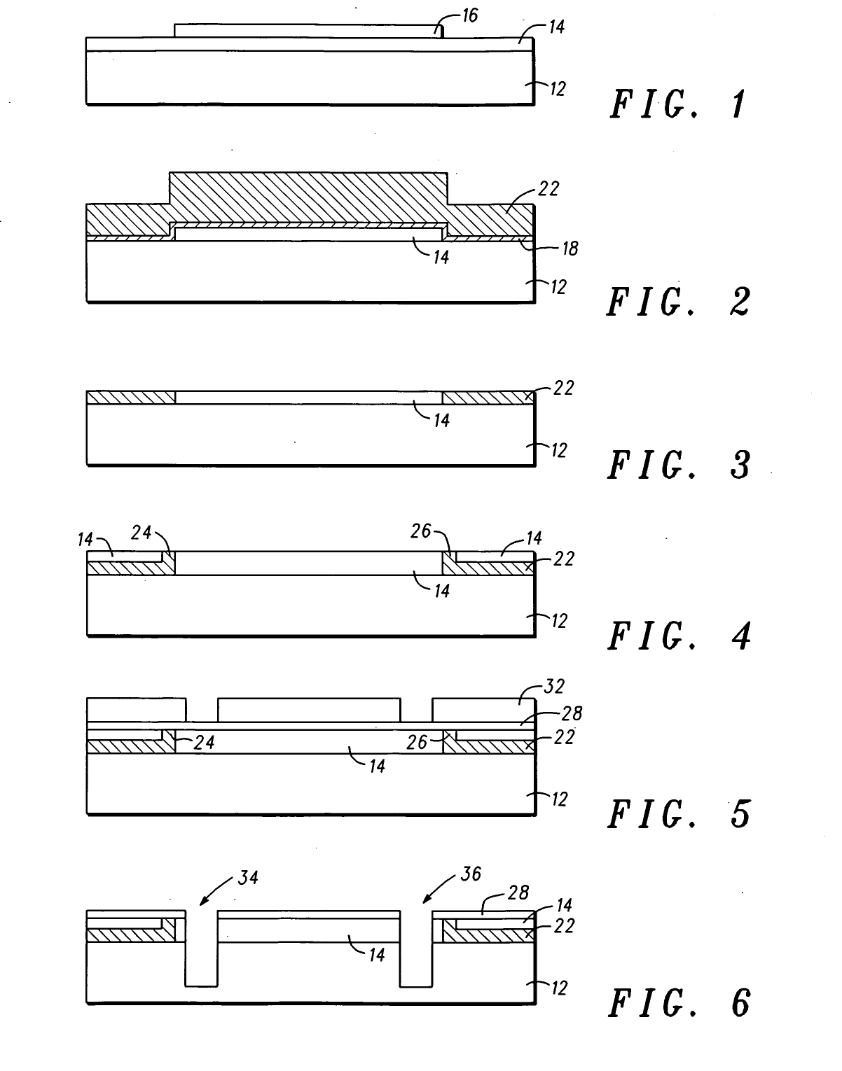

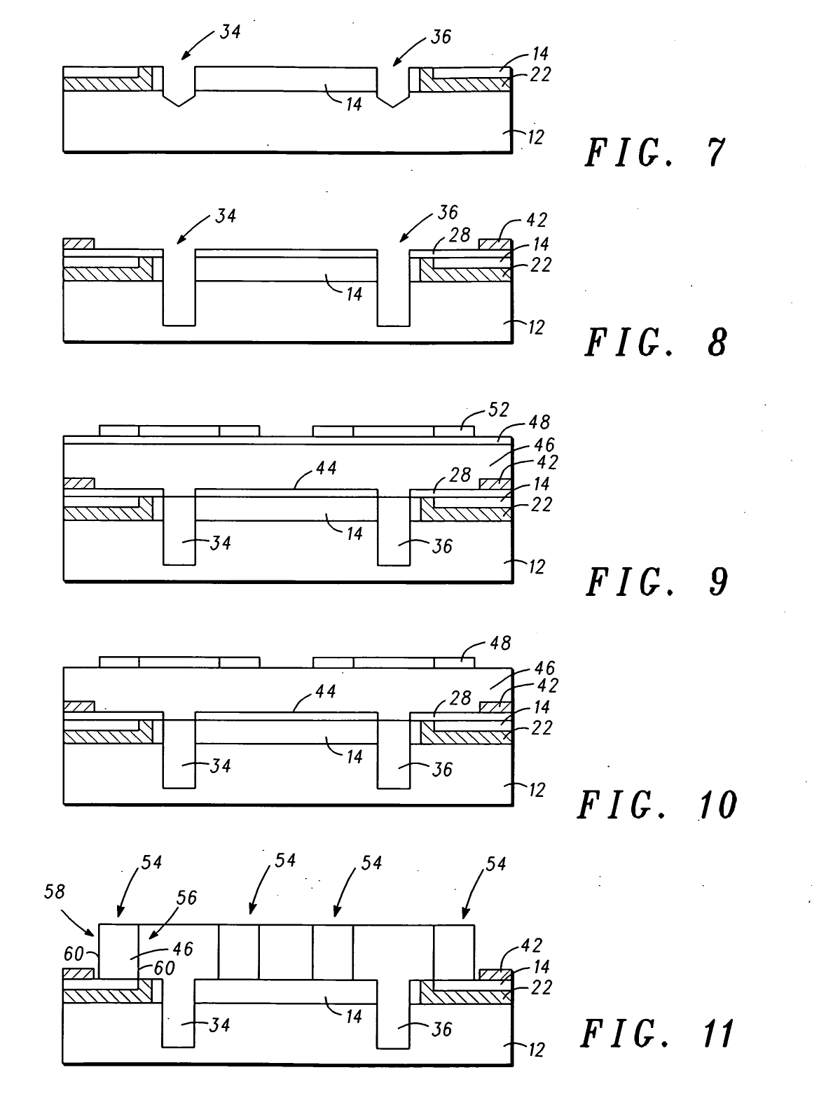

The exemplary embodiments described herein illustrate exemplary processes requiring only front side alignment and processing to fabricate fuel cells with a semiconductor-like process on silicon, glass, ceramic, plastic, metallic, or a flexible substrate. Referring to FIG. 1, a thin layer 14 of insulating film, preferably a TEOS oxide or Tetraethyl Orthosilicate (OC₂H₅)₄, is deposited on a substrate 12 to provide insulation for subsequent metallization layers which may be an electrical back plane (for I/O connections, current traces, etc.). An optional insulating layer may be formed between the substrate 12 and the thin layer 14. The thickness of the thin layer 14 may be in the range of 0.1 to 1.0 micrometers, but preferably would be 0.5 micrometers. A photoresist 16 is formed and patterned (FIG. 1) on the TEOS oxide layer 14 and the TEOS oxide layer 14 is etched (FIG. 2) by dry or wet chemical methods. The photoresist 16 is removed and a Tantalum/copper layer 18 is deposited on the substrate 12 and the TEOS oxide layer 14 to act as a seed layer for the deposition of a copper layer 22 for providing contacts to elements described hereinafter. The thickness of the Tantalum/copper layer 18 may be in the range of 0.05 to 0.5 micrometers, but preferably would be 0.1 micrometers. The copper layer 22 may have a thickness in the range of 0.05-2.0 micrometer, but preferably is 1.0 micrometer. Metals for the copper layer 22 other than copper, may include, e.g., gold, platinum, silver, palladium, ruthenium, and nickel.

The copper layer 22 is formed with a chemical mechanical polish (FIG. 3), and further similar processing in a manner known to those skilled in the art results in the formation of vias 24, 26 integral to the copper layer 22 (FIG. 4). It should be noted that a lift off based process may be used to form the patterned layer 22 and vias 24, 26.

Referring to FIG. 5, in accordance with a first exemplary embodiment, an etch stop film 28 having a thickness of about 0.1 to 10.0 micrometers is formed by deposition on the TEOS oxide layer 14 and the vias 24, 26. The film 28 preferably comprises Titanium/gold, but may comprise any material to selectively deep silicon etch. Another photoresist 32 is formed and the pattern is transferred from the photoresist layer 32 to layer 28 and subsequently to layer 14 by wet or dry chemical etch processes. A deep reactive ion etch is performed to create channels 34, 36 (FIG. 6) to a depth of between 5.0 to 100.0 micrometers, for example. The channels 34, 36 preferably have a 1:10 aspect ratio with minimum feature size of 10 micrometers or smaller. The photoresist 32 is then removed.

In a second exemplary embodiment, after the process steps shown in FIG. 4, an oxide patterning and an anisotropic silicon etch or a plasma based silicon etch may be performed to form the channels 34, 36 (FIG. 7). A deep silicon electrochemical etch is then performed by applying an anodic potential in HF electrolyte to extend the channels 34, 36 into the substrate 12 (as shown in FIG. 8). The channels 34, 36 preferably have a 1:100 aspect ratio with minimum feature size of 1.0 to 5.0 micrometers. The size and depth of the via can be controlled by modifying the electrolyte concentration, anodic potential and etch time. To improve the directionality of via formed electrochemically, a notch in Si can be chemically etched that act as nucleation site for electrochemical growth of via/pore. An etch stop layer 28 is then formed on the thin layer 14.

Referring to FIG. 8 and in accordance with both the first and second exemplary embodiments, a second copper layer 42 is formed and patterned on the etch stop film 28 for providing contacts to elements described hereinafter (alternatively, a lift-off process could be used). The copper layer 42 may have a thickness in the range of 0.01-1.0 micrometers, but preferably is 0.1 micrometers. Metals for the copper layer 42 other than copper, may include, e.g., gold, platinum, silver, palladium, ruthenium, and nickel.

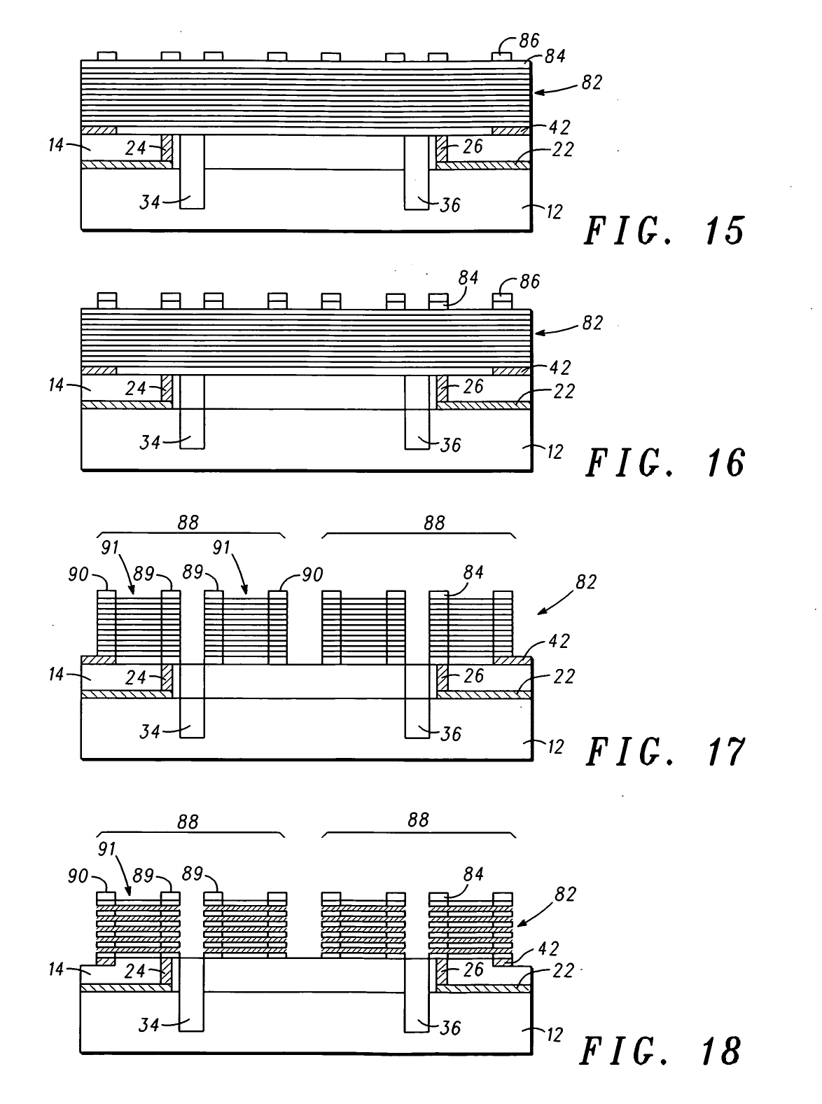

Two methods of forming anodes/cathodes over the etch stop layer 28, copper layer 42, and channels 34 and 36 will now be described. The first method comprises patterning a solid proton conducting electrolyte (FIGS. 9-14) and the second method comprises patterning a multiple layers of metals (FIGS. 15-22).

Referring to FIG. 9, the first method comprises a solid proton conducting electrolyte 46 formed on the surface 44 and the second metal layer 42. The channels 34 and 36 may be plugged with an oxide (not shown), for example, to prevent the solid proton conducting electrolyte 46 from entering the channels 34 and 36. The oxide would be subsequently removed. The plug may not be required if the diameter of the channels 34 and 36 is small. Examples of the solid proton conducting electrolyte 46 include polyelectrolytes such as perfluorosulphonic acid (Nafion®) film, acid doped poly benzimidazole, sulfonated derivates of polystyrene, poly phosphozene, polyether ether ketone, poly(sulfone), poly(imide) and poly(arylene) ether sulphone. Perfluorosulphonic acid has a very good ionic conductivity (0.1 S/cm) at room temperature when humidified. The solid proton conducting electrolyte 46 preferably is spin coated, but other methods such as casting or lamination of a prefabricated Nafion film or inkjet printing of Nafion solution could also be used.

Electrolyte films on various substrates, e.g., glass, plastic, and silicon, can be made by spin coating a solution containing electrolyte and other additives such as solvent and/or water. The substrate may be conducting, semiconducting, insulating, or semi-insulating. The substrate may also have a film or multilayers of conducting, semiconducting, semi-insulating or insulating material thereon. Electrolyte film thickness can be controlled by changing the spin rate and viscosity of the solution containing electrolyte, e.g., 10 wt % Nafion in water at 1000 rpm gives a thickness of 650 nm. Film thickness can also be changed by spin coating multiple times. The films may be dried between room temperature and 100° C. to remove excess water and solvent from the film after spin coating. Thicker electrolyte films can be made either by casting an electrolyte containing-solution or by bonding a free standing electrolyte membrane. Bonding may be performed by hot compression technique at elevated temperature (up to temperatures corresponding to the glass transition temperature of the electrolyte) using applied pressure. After forming the electrolyte layer 46 by one of the above mention techniques, a mask layer 48 is deposited on the solid proton conducting electrolyte 46 and a pattern forming layer 52 is formed on the mask layer 48. Mask layer 48 is chosen such that it is resistant to the electrolyte patterning processes such as plasma etch and can be a conducting, semiconducting, or insulating layer. The pattern forming layer 52 can be a photo-patternable layer such as photoresist processed by conventional semiconductor processes such as spin coating and lithography. Alternatively, the pattern forming layer 52 can be a porous layer formed by self assembly processes such as self-assembly of porous anodic alumina, block co-polymer self-assembly, or colloidal templating. Using a self-assembly process to form layer 52 allows for non-lithographic fabrication of patterned electrolytes and therefore low cost and high throughput. The pattern from layer 52 is then transferred to the mask layer 48 (FIG. 9) by conventional patterning processes such as wet or dry chemical etching, sputtering or ion-milling. The mask layer 48 is optional when the pattern forming layer 52 is used as a mask to directly pattern the electrolyte 46.

Referring to FIGS. 10-11, the mask layer 48 not protected by the pattern forming layer 52 is removed with a chemical etch. After the pattern forming layer 52 is removed, the solid proton conducting electrolyte 46 not protected by the mask layer 48, is removed to form a pedestal 54 comprising an anode inner side 56 and a concentric cathode outer side 58. The concentric outer side 58 and the anode inner side 56 are separated by the solid proton conducting electrolyte 46. In a preferred embodiment, the removal of the solid proton conducting electrolyte is accomplished with a dry plasma etch. The plasma gas may be argon or other chemistries, but preferably is oxygen. This oxygen-based, high-density etch will work over a large process window. Representative conditions are as follows: 900 W u-wave, 50 W RIE, 30 sccm O₂, 4 mT, with He-cooled chuck. Etch rates may reach 5 um/minute. Alternatively, the electrolyte may be patterned by milling, laser-machining or sputtering techniques. The pedestal 54 preferably has a diameter of 10 to 100 microns. The distance between each pedestal 54 would be 10 to 100 microns, for example. Concentric as used herein means having a structure having a common center, but the anode and cathode walls may take any form and are not to be limited to circles. For example, the pedestals 54 may alternatively be formed by etching orthogonal trenches. The etch stop layer 28 not protected by the pedestals 54 and the copper layer 42 is removed.

The side walls 60 are coated with an electrocatalyst 62 for anode and cathodic fuel cell reactions by wash coat or some other deposition method such as CVD, ALD, PVD, electrochemical or chemical deposition approach (FIG. 12). A multi-metal layer 64 comprising an alloy of two metals, e.g., silver/gold, copper/silver, platinum/copper, nickel/copper, copper/cobalt, nickel/zinc or nickel/iron, and having a thickness in the range of 100-500 um, but preferably 200 um, is deposited on the surface 44 and vias 24, 26. The multi-metal layer 64 is then wet etched to remove one of the metals, leaving behind a porous material. The porous metal layer could also be formed by other methods such as templated self-assembled growth or sol-gel deposition.

Alternatively, the porous layer may be first grown by the above mentioned techniques followed by coating the walls of the porous layer and/or the porous layer-electrolyte interface with an electrocatalyst. The electrocatalyst may be coated by CVD, ALD, PVD, electrochemical or chemical deposition of electrocatalyst from solution.

Then a capping layer 66 is formed and patterned above the electrolyte material 46 and the multi-metal layer 64. The capping layer 66 is substantially impermeable to hydrogen and may comprise, e.g., a conducting layer, a semiconducting layer, or an insulating layer, but preferably comprises a dielectric layer. FIG. 12 shows the case of an insulating capping layer. If a conducting or semiconducting layer were used, the capping layer width is such that there would be no short between the anode and cathode.

Referring to FIG. 13, the thickness of the substrate 12 is reduced to expose the channels 34, 36, e.g., by backside lapping or chemical etching of the bottom surface 76 of the substrate 12 of the finished wafer. This will expose the channels formed under the anode areas for providing hydrogen fuel access. The back side lapping can either be done on an entire substrate or individual die or a combination of both processes (entire substrate followed by a single die thinning). The back side lapping is done such that the front side structure is not impacted by the process. The mechanical method of lapping can thin the entire substrate down to 50-100 micron thickness eventually leading to opening of the channels 34, 36 (FIG. 6). The same can be obtained by using wet chemical or dry etch processes to thin the entire substrate. For example, a silicon substrate can be etched using heated potassium hydroxide (KOH), or other suitable chemical etchants. In an alternate embodiment, a plurality of channels can be created from the back side using a electrochemical etch by applying an anodic potential in an electrolyte, for example, hydrofluoric acid, to extend the channels into the substrate 12 from the back side, eventually linking to the channels 34, 36 created from front side (FIG. 8). The size and depth of the channels can be controlled by modifying the electrolyte concentration, anodic potential and etch time. The process can be implemented on individually diced micro fuel cells as well. After this step the individual micro fuel cell arrays can be diced and packaged or two or more cells can be connected on the wafer as desired and then packaged on a substrate for structural support as well as for providing fuel gas access. The optional material filled in the channel is removed a selective wet or dry chemical etch.

The silicon substrate 12 is positioned on a structure 72 for transporting hydrogen to the channels 34, 36. The structure 27 may comprise a cavity or series of cavities (e.g., tubes or passageways) formed in a ceramic material, for example. Hydrogen would then enter the hydrogen sections 68 of multi-metal layer 64 above the channels 34, 36. Since sections 68 are capped with the capping layer 66, the hydrogen would stay within the sections 68. Oxidant sections 74 are open to the ambient air, allowing air (oxygen) to enter oxidant sections 74. Oxidant section 74 may optionally be patterned, such as with a via through the multi-metal layer 64, to improve passage of air.

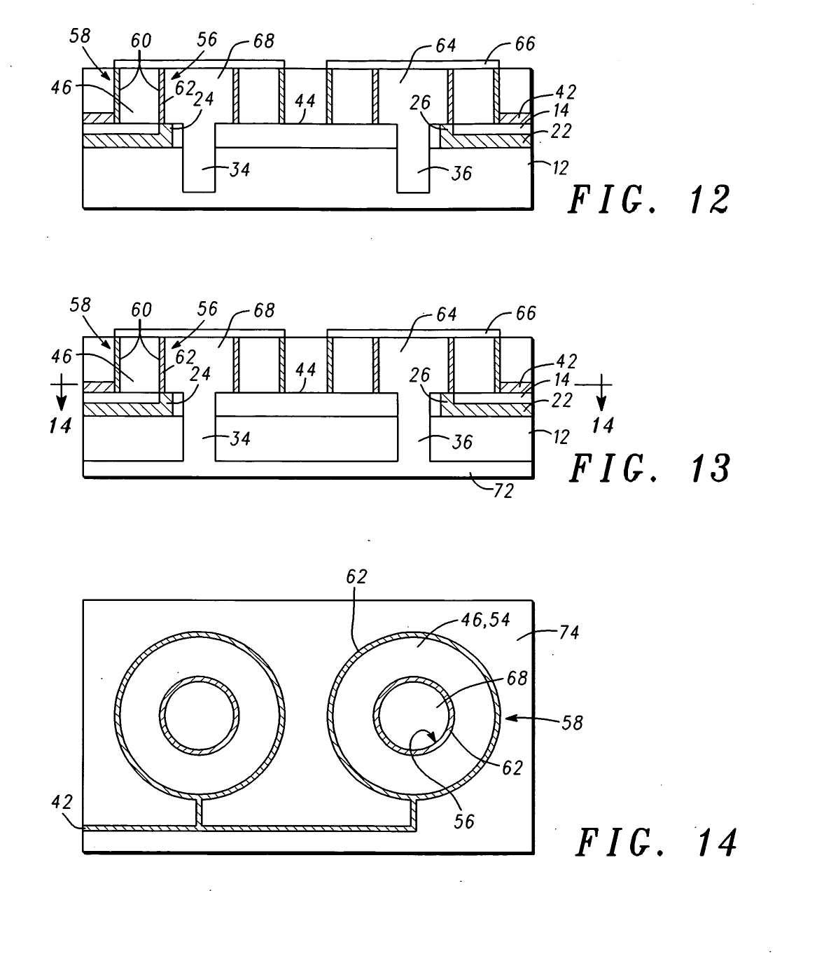

FIG. 14 illustrates a top view of adjacent fuel cells fabricated in the manner described as concentric circles in reference to FIGS. 1-13. The electrolyte material solid proton conducting electrolyte 46 will form a physical barrier between the anode 56 (hydrogen feed) and cathode 58 (air breathing) regions. Gas manifolds (not shown) are built into the bottom packaging substrate 72 to feed fuel, e.g., hydrogen gas, to all the anode regions.

Referring to FIG. 15, the second method of forming anodes/cathodes over the thin layer 14, copper layer 42, and channels 34 and 36 will now be described. Referring to FIG. 15, multiple layers 82 comprising alternating conducting material layer, e.g., metals such as silver/gold, copper/silver, nickel/copper, copper/cobalt, nickel/zinc and nickel/iron, and having a thickness in the range of 100-500 um, but preferably 200 um (with each layer having a thickness of 0.1 to 10 micron, for example, but preferably 0.1 to 1.0 microns), are deposited on the copper layer 22 and a seed layer 28 above the layer 14. If the channels 34, 36 are small, they do not need to be plugged prior to depositing the multiple layers 82. A dielectric layer 84 is deposited on the multiple layers 82 and a resist layer 86 is patterned and etched on the dielectric layer 84.

Referring to FIGS. 16-17, using a chemical etch, the dielectric layer 84 not protected by the resist layer 86, is removed. Then, after the resist layer 86 is removed, the multiple layers 82, not protected by the dielectric layer 84, are removed to form a pedestal 88 comprising a center anode 89 (inner section) and a concentric cathode 90 (outer section) surrounding, and separated by a cavity 91 from, the anode 89. The pedestal 88 preferably has a diameter of 10 to 100 microns. The distance between each pedestal 88 would be 10 to 100 microns, for example. Alternatively, the anode 89 and cathode 90 may be formed simultaneously by templated processes. In this process, the pillars will be fabricated using a photoresist or other template process followed by a multi-layer metal deposition around the pillars forming the structure shown in FIG. 17. Concentric as used herein means having a structure having a common center, but the anode, cavity, and cathode walls may take any form and are not to be limited to circles. For example, the pedestals 88 may alternatively be formed by etching orthogonal trenches.

The multiple layers 82 of alternating metals are then wet etched to remove one of the metals, leaving behind layers of the other metal having a void between each layer (FIG. 18). When removing the alternate metal layers, care must be taken in order to prevent collapse of the remaining layers. This may be accomplished, with proper design, by etching so that some undissolved metal portions of the layers remain. This may be accomplished by using alloys that are rich in the metal being removed so the etching does not remove the entire layer. Alternatively, this may also be accomplished by a patterning of the layers to be removed so that portions remain between each remaining layer. Either of these processes allow for exchange of gaseous reactants through the multiple layers. The metal remaining/removed preferably comprises gold/silver, but may also comprise, for example, nickel/iron or copper/nickel.

The side walls 92 are then coated with an electrocatalyst 94 for anode and cathodic fuel cell reactions by wash coat or some other deposition methods such as CVD, PVD or electrochemical methods (FIG. 19). Then the layers 82 are etched down to the substrate 12 and an electrolyte material 96 is placed in the cavity 91, and the layer 28 not protected by the pedestals 88 and the conductive layer 42 is removed. A capping layer 98 is formed (FIG. 20) and patterned (FIG. 21) above the electrolyte material 96. Alternatively, the electrolyte material 96 may comprise, for example, perflurosulphonic acid (Nafion®), phosphoric acid, or an ionic liquid electrolyte. Perflurosulphonic acid has a very good ionic conductivity (0.1 S/cm) at room temperature when humidified. The electrolyte material also can be a proton conducting ionic liquids such as a mixture of bistrifluromethane sulfonyl and imidazole, ethylammoniumnitrate, methyammoniumnitrate of dimethylammoniumnitrate, a mixture of ethylammoniumnitrate and imidazole, a mixture of elthylammoniumhydrogensulphate and imidazole, flurosulphonic acid and trifluromethane sulphonic acid. In the case of liquid electrolyte, the cavity needs to be capped to protect the electrolyte from leaking out.

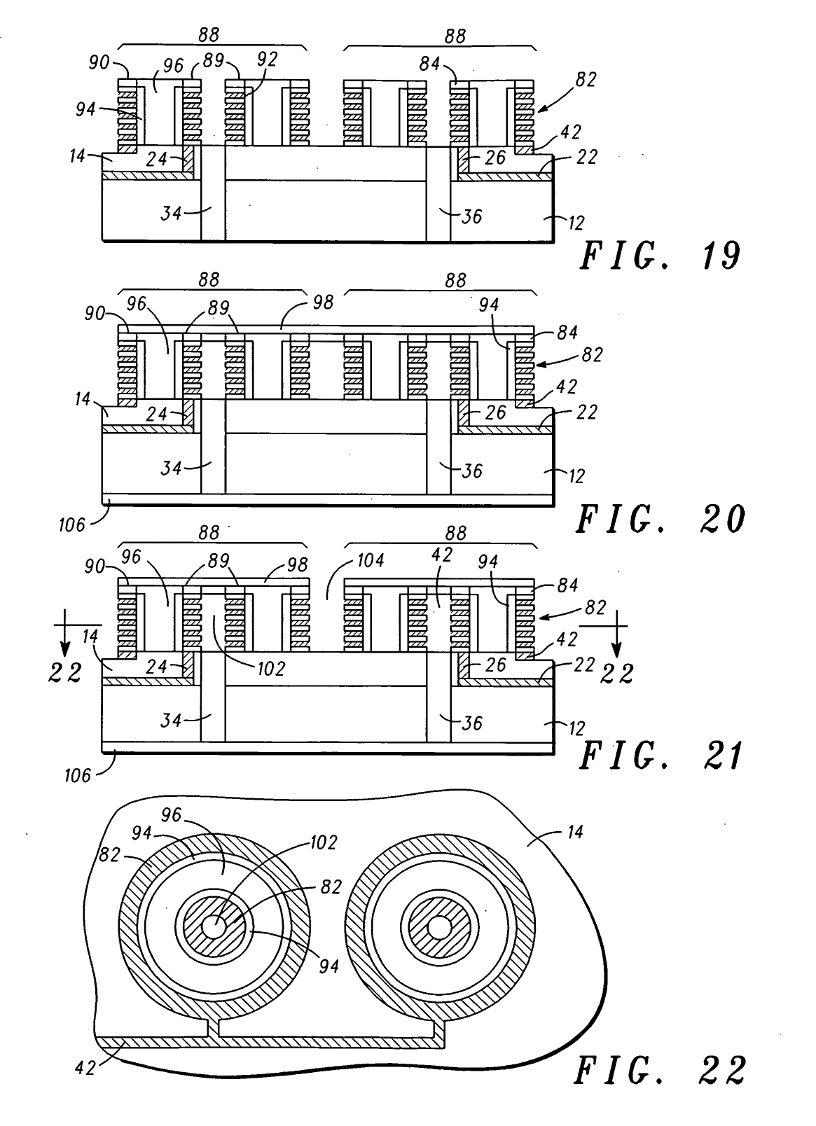

FIG. 22 illustrates a top view of adjacent fuel cells fabricated in the manner described in reference to FIG. 15-21. The silicon substrate 12, or the substrate containing the micro fuel cells, is positioned on a structure (gas manifold) 106 for transporting hydrogen to the channels 34, 36. The structure 106 may comprise a cavity or series of cavities (e.g., tubes or passageways) formed in a ceramic material, for example. Hydrogen would then enter the hydrogen sections 102 of alternating multiple layers 82 above the cavities 34, 36. Since sections 102 are capped with the capping layer 98, the hydrogen would stay within the sections 102. Oxidant sections 104 are open to the ambient air, allowing air (including oxygen) to enter oxidant sections 104.

After filling the cavity 91 with the electrolyte material 94, it will form a physical barrier between the anode (hydrogen feed) and cathode (air breathing) regions 68, 74. Gas manifolds 106 are built into the bottom packaging substrate to feed hydrogen gas to all the anode regions. Since it is capped on the top, it will be like a dead end anode feed configuration fuel cell.

The first and second exemplary embodiments disclosed herein, which may be combined with either of the two methods of forming anodes and cathodes therewith, provide a method of fabricating a fuel cell that requires only front side alignment and processing, increases the surface area for a gas to access the anode material, eliminates constraints on wafer size and thickness, and provides for sub-twenty micron vias for gas access to each cell for increasing cell, and hence, power density.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method for fabricating a fuel cell, comprising:
etching the first side of a substrate to define a channel;
forming a pedestal on the first side of the substrate, the pedestal having an anode side defining a fuel region aligned with the channel, and a cathode side;
positioning an electrolyte between the cathode side and the anode side;
capping the fuel region with an insulator; and
removing a portion of the substrate from a second side to expose the channel.

2. The method of claim 1 wherein the etching step comprises performing a deep reactive ion etch.

3. The method of claim 2 wherein the etching step comprises etching to provide a channel having a diameter of 5 to 20 micrometers.

4. The method of claim 2 wherein the etching step comprises etching to provide a channel having a 1:10 aspect ratio.

5. The method of claim 2 wherein the etching step comprises etching to provide a channel having a minimum feature size of 10 micrometers.

6. The method of claim 1 wherein the etching step comprises performing an electrochemical etch.

7. The method of claim 6 wherein the etching step comprises etching to provide a channel having a depth of 5 to 200 micrometers.

8. The method of claim 6 wherein the etching step comprises etching to provide a channel having a 1:100 aspect ratio.

9. The method of claim 6 wherein the etching step comprises etching to provide a channel having a minimum feature size of 1.0 to 5.0 micrometers.

10. The method of claim 1 further comprising capping the channel with a material to prevent subsequent steps from filling the channel.

11. The method of claim 1 wherein the forming step comprises patterning a solid proton conducting electrolyte over the first side of the substrate to define the anode side and the cathode side separated by the solid proton conducting electrolyte.

12. The method of claim 11 wherein the forming step further comprises coating the anode and cathode sides with an electrocatalyst, wherein the anode side defines a fuel region and the cathode side defines an oxidant region.

13. The method of claim 1 wherein the forming step comprises:
patterning a porous metal layer on the first side of the substrate to define the anode side and the cathode side separated by a cavity; and
filling the cavity with a proton conducting electrolyte material.

14. The method of claim 1 wherein the forming step comprising:
depositing a multi-metal layer on the first side of the substrate;
etching at least one metal from the multi-metal layer forming a porous metal layer therefrom;
forming a portion of the porous metal layer resulting in a center anode portion aligned with the channel, and a concentric cathode portion separated by a concentric cavity;
optionally filling the concentric cavity with a porous insulating matrix;
filling the concentric cavity with an electrolyte; and
capping the center anode portion and the concentric cavity.

15. A method for fabricating a fuel cell, comprising:
forming a first electrical conductor accessible at a first side of a substrate;
etching the first side of a substrate to provide a plurality of channels;
forming a second electrical conductor accessible at the first side of the substrate;
forming a plurality of pedestals on the first side of the substrate, each of the pedestals having an anode coupled to the first electrical conductor and a cathode coupled to the second electrical conductor, and each pedestal further defining a fuel region adjacent the anode and aligned with one of the plurality of channels, wherein forming the pedestal includes positioning an electrolyte between the anode and cathode;
capping each of the fuel regions with an insulator; and
removing a portion of the substrate from a second side to expose the plurality of channels.

16. The method of claim 15 wherein the forming a plurality of pedestals step comprises patterning a solid proton conducting electrolyte over the first side of the substrate to define the anode side and the cathode side separated by the solid proton conducting electrolyte.

17. The method of claim 16 wherein the forming a plurality of pedestals step further comprises coating the anode and cathode sides with an electrocatalyst, wherein the anode side defines a fuel region and the cathode side defines an oxidant region.

18. The method of claim 15 wherein the forming a plurality of pedestals step comprises:
patterning a porous metal layer on the first side of the substrate to define the anode side and the cathode side separated by a cavity; and
filling the cavity with a proton conducting electrolyte material.

19. The method of claim 15 wherein the forming a plurality of pedestals step comprising:
depositing a multi-metal layer on the first side of the substrate;
etching at least one metal from the multi-metal layer forming a porous metal layer therefrom;
forming a portion of the porous metal layer resulting in a center anode portion aligned with the channel, and a concentric cathode portion separated by a concentric cavity;
optionally filling the concentric cavity with a porous insulating matrix;
filling the concentric cavity with an electrolyte; and
capping the center anode portion and the concentric cavity.

20. The method of claim 15 further comprising forming a gas manifold on the second side, the gas manifold comprising cavities aligned with the plurality of channels.
